(19) United States
(12) Patent Application Publication
(10) Pub. No.: US 2014/0341559 A1
(43) Pub. Date: Nov. 20, 2014

(54) COMMUNICATION DEVICE, COMMUNICATION SYSTEM, AND COMMUNICATION METHOD

(71) Applicant: FUJITSU LIMITED, Kawasaki-shi (JP)

(72) Inventor: Satoru Saitoh, Kawasaki (JP)

(73) Assignee: FUJITSU LIMITED, Kawasaki-shi (JP)

(21) Appl. No.: 14/265,913

(22) Filed: Apr. 30, 2014

(30) Foreign Application Priority Data
May 16, 2013 (JP) 2013-104544

(51) Int. Cl. H04L 1/00; H04L 29/06; H04L 1/08

(52) U.S. Cl. CPC H04L 1/0042; H04L 1/08; H04L 69/22
USPC 398/1

(57) ABSTRACT

A communication device includes a frame processing unit configured to allocate a plurality of first regions and a plurality of second regions in a frame, and contain portions of a packet in the plurality of first regions, a transmitting unit configured to transmit the frame, and a receiving unit configured to receive a retransmission request for the packet, wherein the frame processing unit contains a retransmission data packet in at least one of the plurality of second regions in accordance with the retransmission request received by the receiving unit.

### CROSS-REFERENCE TO RELATED APPLICATION

This application is based upon and claims the benefit of priority of the prior Japanese Patent Application No. 2013-104544, filed on May 16, 2013, the entire contents of which are incorporated herein by reference.

### FIELD

The embodiments discussed herein are related to a communication device, communication system, and communication method.

### BACKGROUND

High speed optical transmission methods are standardized as demand for communication increases. For example, International Telecommunication Union Telecommunication Standardization Sector (ITU-T) Recommendation G.709 describes a technology for an optical transport network (OTN) with speeds between approx. 1.25 to 100 Gbps.

A significantly higher level of communication quality regarding the communication within a transmission device connecting to backbone networks such as an OTN as compared with a communication device accessing a network having a slow transmission speed. The communication within the communication device is performed, for example, via a backboard connecting communication processing cards (interface cards) for each transmission path. Power wiring, an optical waveguide, optical fiber, etc. are provisioned to the backboard to transmit the main signal.

This backboard is installed, for example, on the back side of a rack housing the transmission device, and so is susceptible to the effects of noise and heat from various electrical components in the device. For this reason, the main signal transmitted through the backboard is prone to degradation of communication quality.

As advocated by the Institute of Electrical and Electronics Engineers Inc. (IEEE), one proposed solution to this problem is the adding of an error correction encoding, such as Forward Error Correction (FEC) that has demonstrated sufficient error correction capability, to the main signal. As with Internet Protocol (IP), another solution is to divide and transmit the main signal into multiple packets, and retransmit any packets having errors.

Regarding packet retransmission methods, International Publication Pamphlet No. 01-99355 describes the detection of packets retransmitted by adding a sequence number to the packet. Japanese Laid-open Patent Publication No. 2000-341233 describes the inclusion of additional overhead desirable for error detection during signal transmission into the signal.

### SUMMARY

According to an aspect of the invention, a communication device includes a frame processing unit configured to allocate a plurality of first regions and a plurality of second regions in a frame, and contain portions of a packet in the plurality of first regions, a transmitting unit configured to transmit the frame, and a receiving unit configured to receive a retransmission request for the packet, wherein the frame processing unit contains a retransmission data packet in at least one of the plurality of second regions in accordance with the retransmission request received by the receiving unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a transmission device;

FIG. 2 is a configuration diagram of a communication device related to a comparison example;

FIG. 3 is a time flowchart illustrating an example of timing of a transmission processing and a reception processing of packets related to the comparison example;

FIG. 4 is a configuration diagram illustrating an example of a frame;

FIGS. 5A and 5B are configuration diagrams illustrating example packets, in which FIG. 5A illustrates a retransmission request packet and FIG. 5B illustrates a retransmission data packet;

FIG. 6 is a configuration diagram of a communication device related to an embodiment;

FIG. 7 is a flowchart of the transmission processing of a frame;

FIG. 8 is a flowchart of the control processing of valid data;

FIG. 9 is a time chart illustrating an example of the transmission processing of a frame;

FIG. 10 is a graph illustrating an example of changes in the bandwidth of data regions and stuff regions;

FIG. 11 is a time chart illustrating another example of the transmission processing of a frame; and

FIG. 12 is a time flowchart illustrating an example of a transmission processing and a reception processing of packets related to an embodiment.

### DESCRIPTION OF EMBODIMENTS

Using an error correction method such as FEC may cause increases in delays of the main signal due to the increased amount of data for the error correction encoding dependent on the error correction capability. Increasing resistance to burst errors using interleaving also increases delays in the main signal due to increases of the buffer amount implemented. Therefore, it is difficult to implement error-free communication within the device by using the error correcting method or using the interleaving.

Thus, a common approach to handling signal errors is to divide and transmit the main signal into many packets, and retransmit any packets having errors. However, retransmission processing is implemented in intervals with normal packet transmission processing. Thus, when a retransmission request packet or a retransmission data packet is dependent on other packets in transmission, the transmission of the retransmission packets has to wait until the completion of the transmission of these dependent packets, which may cause delays in the retransmission packet as a result. This kind of problem is not only limited to the communication within the device, and may also occur in the communication between communication devices.

Hereinafter, the embodiments of a communication device, communication system, and communication method configured to retransmit packets with low delay will be described with reference to the drawings.

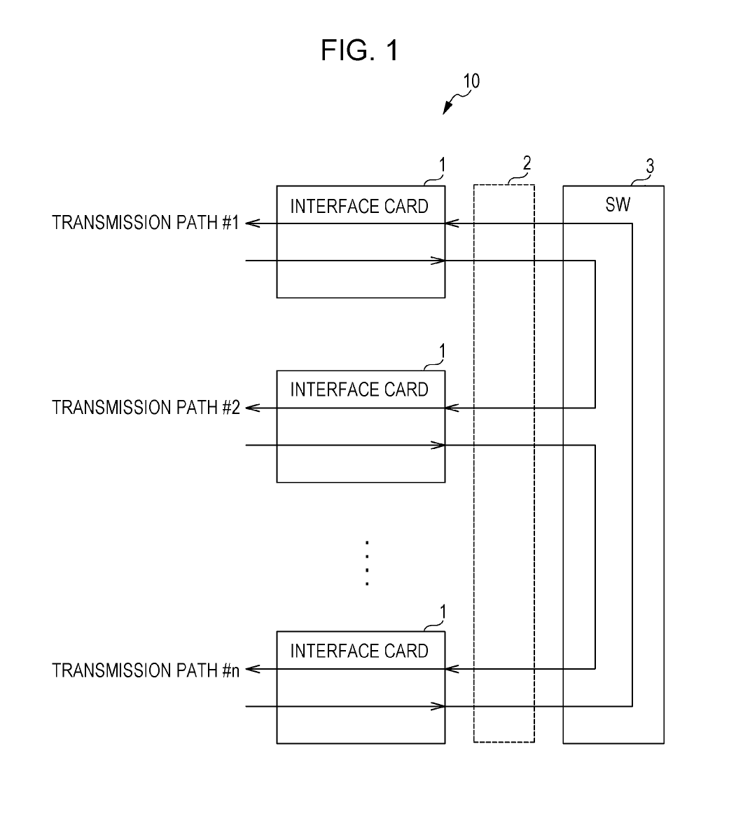

FIG. 1 is a configuration diagram illustrating an example of a transmission device. A transmission device 10 continuously transmits a data signal at a specific communication rate based on ITU-T Recommendation G.709, for example. The format of the data signal is not limited to the OTN frame, and may be an Ethernet (registered trademark) frame or a Synchronous Optical NETwork (SONET) frame.

The transmission device 10 includes multiple interface cards (communication devices) 1, a backboard 2, and a switch card 3. The multiple interface cards 1 are each connected to multiple transmission paths #1 through #n, performing reception processing on the data signal from the transmission paths #1 through #n and transmission processing on the data signal transmitted out the transmission paths #1 through #n.

The multiple interface cards 1 are mutually connected via the switch card 3. The interface cards 1 convert the data signal received from the transmission paths #1 through #n into packets, outputting these packets to the switch card 3. At this time, the interface cards 1 add destination information describing the packet destination to the packet. The switch card 3 outputs the packet to the destination interface card 1. There are two switch cards 3 provisioned for redundancy, an active card and a standby card.

The interface cards 1 reconstruct the packets input from the switch card 3 into the data signal, and transmit this signal out the transmission paths #1 through #n. In this way, the interface card 1 performs packet transmission via the switch card 3 (refer to the arrows).

The multiple interface cards 1 and the switch card 3 are connected to enable communication via wiring provisioned to the backboard 2. The wiring functions as the transmission path for the packet communication, and may be electrical wiring, a light waveguide, or optical fiber, for example.

The backboard 2 is installed, for example, to the back side of a rack housing the transmission device, and the multiple interface cards 1 and the switch cards 3 are contained in multiple slots arranged in parallel on the front of the backboard 2. The multiple interface cards 1 and the switch card 3 are connected to wiring on the backboard 2 via electrical connectors or optical connectors.

The backboard 2 is susceptible to noise and heat generated by the multiple interface cards 1, the switch card 3, and so forth. For this reason, communication quality of packets transmitted to the backboard 2 is susceptible to degradation.

Packet delays increase when correcting errors in packets due to the inclusion of an error correction encoding having sufficient error correction capability, and the amount of data for this error correction encoding dependent on this error correction capability. The interface card 1 is accordingly provisioned with the capability to retransmit packets having errors.

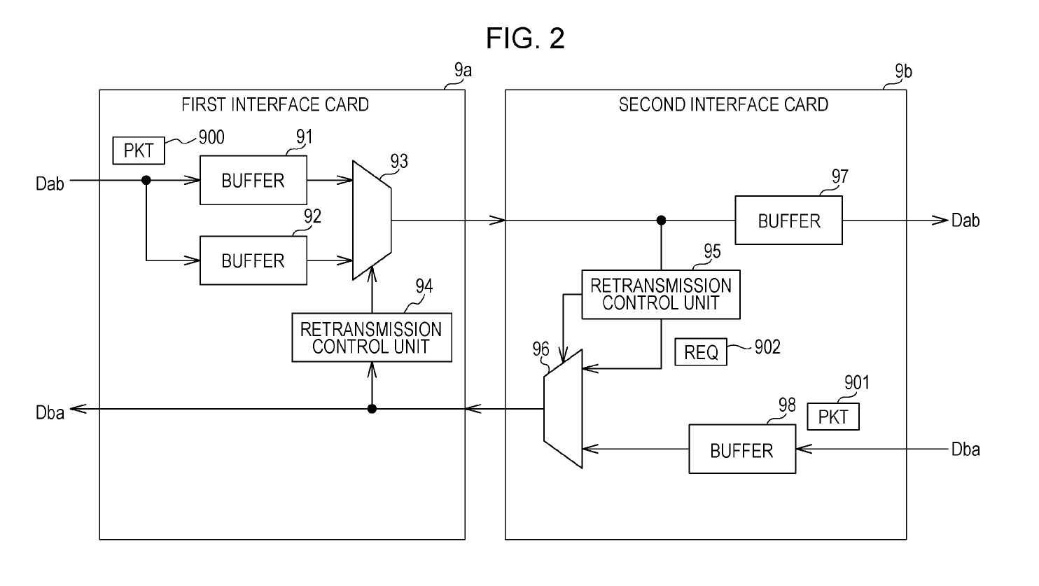

FIG. 2 is a configuration diagram of the communication device related to a comparison example. More specifically, FIG. 2 illustrates a comparative configuration of the aforementioned interface card 1.

FIG. 2 illustrates a first interface card 9a and a second interface card 9b. Hereinafter, the description describes a case in which errors are detected in packets transmitted by the first interface card 9a to the second interface card 9b, and the second interface card 9b transmits a retransmission request packet to the first interface card 9a.

The first interface card 9a includes buffers 91 and 92, a selector 93, and a retransmission control unit 94. The second interface card 9b includes a retransmission control unit 95, a selector 96, and buffers 97 and 98. The first interface card 9a and the second interface card 9b are illustrated as different configurations, but they may have the same configuration.

The first interface card 9a converts a data signal Dab received from transmission paths #1 through #n into a packet 900 and temporarily stores the packet 900 in the buffer 91 before transmitting this to the second interface card 9b via the selector 93. The packet 900 is also stored in the buffer 92 for packet retransmissions. When the retransmission processing is not occurring for the packet 900, the selector 93 is connected to the buffer 91 and not the buffer 92.

The second interface card 9b converts a data signal Dba received from transmission paths #1 through #n into a packet 901 and temporarily stores the packet 901 in the buffer 98 before transmitting this to the first interface card 9a via the selector 96. When the retransmission request processing is not occurring for the packet 900, the selector 96 is connected to the buffer 98 and not the retransmission control unit 95.

The second interface card 9b temporarily stores the packet 900 received from the first interface card 9a in the buffer 97, then restores the data signal Dab and transmits this to the transmission paths #1 through #n. When the retransmission processing occurs for the packet 900, the buffer 97 causes a delay by storing the packet 900 for at least the amount of time to retransmit so that restoration processing of the data signal Dab is performed correctly.

When an error is detected in the received packet 900, the retransmission control unit 95 switches the selector 96 connection from the buffer 98 to the retransmission control unit 95. The retransmission control unit 95 generates a packet including a retransmission request packet REQ, and transmits this to the first interface card 9a via the selector 96. After the transmission processing for the retransmission request packet REQ finishes, the retransmission control unit 95 switches the selector 96 connection from the retransmission control unit 95 to the buffer 98.

The first interface card 9a restores the packet 901 received from the second interface card 9b into the data signal Dba, and transmits this out the transmission paths #1 through #n. When the retransmission request packet REQ is detected in the received packet 901, the retransmission control unit 94 switches the selector 93 connection from the buffer 91 to the retransmission buffer 92.

As a result, the packet for which the retransmission request packet REQ was transmitted (hereinafter, referred to as “the retransmission data packet”), within the packets 900 stored in the retransmission buffer 92, is retransmitted to the second interface card 9b via the selector 93. The retransmission data packet is stored in the buffer 97 of the second interface card 9b, and restored into the data signal Dab along with the other stored packets.

The subsequent packets 900 are sequentially stored in the buffer 91 during the retransmission processing. When the retransmission processing finishes, the retransmission control unit 94 returns the selector 93 connection from the retransmission buffer 92 to the buffer 91. As a result, the packets 900 that could not be transmitted during the retransmission processing are output from the buffer 91, and transmitted to the second interface card 9b.

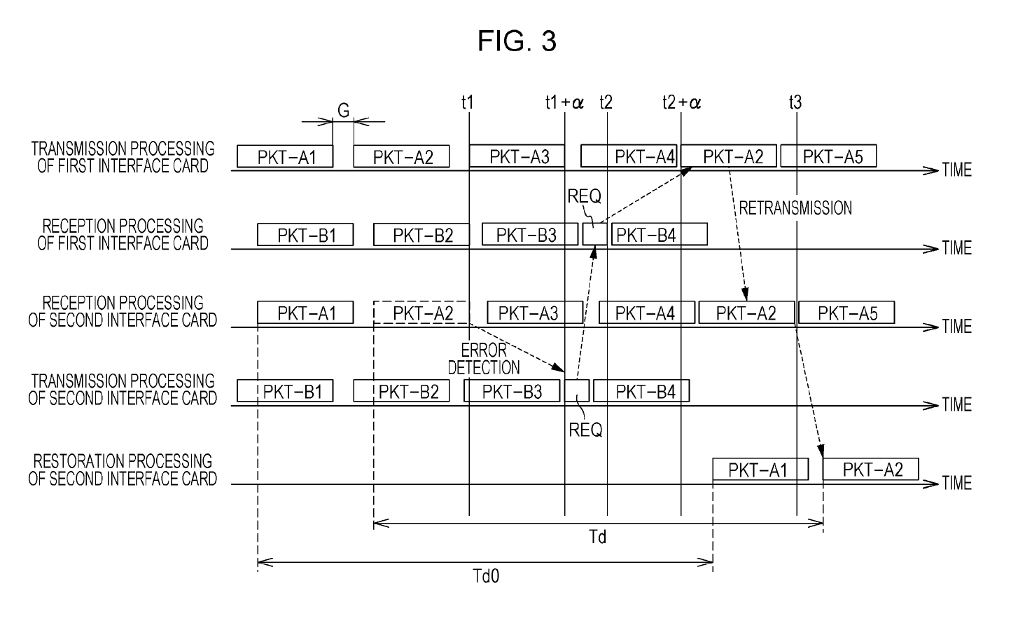

FIG. 3 is a time flowchart illustrating an example of timing of a transmission processing and a reception processing of packets related to the comparison example. The packets transmitted from the first interface card 9a are labeled in FIG. 3 as “PKT-A1” through “PKT-A5” in the order they are transmitted. Packets transmitted from the second interface card 9b are labeled as “PKT-B1” through “PKT-B5” in the order they are transmitted.

FIG. 3 illustrates the timing in which an error in the packet PKT-A2 transmitted by the first interface card 9a is detected by the second interface card 9b, and the first interface card 9a retransmits the packet PKT-A2 in response to the retransmission request packet REQ. From the top of the page, FIG. 3 illustrates timings of the transmission processing and reception processing for the first interface card 9a, and the transmission processing, reception processing, and restoration processing for the second interface card 9b.

At a timing t1, the second interface card 9b detects an error in the packet PKT-A2 transmitted by the first interface card 9a. At the timing t1, the second interface card 9b is transmitting the packet PKT-B3, and so transmits the retransmission request packet REQ for the packet PKT-A2 after the current transmission finishes. Therefore, the transmission of the retransmission request packet REQ is delayed by the wait until the transmission of the packet PKT-B3 finishes, which results in a transmission at a timing t1+α.

The retransmission request packet REQ is inserted into an interval between the packet PKT-B3 and the packet PKT-B4. The communication rate between the interface cards 9a and 9b is set higher than the communication rate for the data signals Dab and Dba to include the bandwidth used for retransmitting packets. For this reason, the interval G corresponding to the amount of bandwidth used for retransmitting packets is provisioned.

At a timing t2, the first interface card 9a transmits the retransmission request packet REQ. At the timing t2, the first interface card 9a is transmitting the packet PKT-A4, and so transmits the retransmission data packet PKT-A2 after the current transmission finishes. Therefore, the transmission of the retransmission data packet PKT-A2 is delayed by the wait until the transmission of the packet PKT-A4 finishes, which results in a transmission at a timing t2+α. At this time, the packet interval G is sandwiched so that the packet stored in the buffer 91 during the transmission of the packet PKT-A2 is transmitted without any delay.

At a timing t3, the second interface card 9b receives the retransmission data packet PKT-A2 transmitted by the first interface card 9a. The second interface card 9b restores the data signal Dab from the retransmission data packet PKT-A2 along with the packet PKT-A1 previously received.

As previously described, the second interface card 9b stores the received packet PKT-A1 in the buffer 97 for a specific time Td0. Here, the time Td0 is longer than a delay time Td from the retransmission of the packet PKT-A2, as the time taken to retransmit packets from the first interface card 9a is included.

Therefore, the second interface card 9b correctly restores the data signal Dab from the packets PKT-A1 and PKT-A2. That is to say, the data signal Dab is successfully restored from packets without errors, and the data signal Dab is transmitted at a specific transfer rate for the transmission device as a whole by only having to wait for the retransmission time included by design.

However, as previously described, the retransmission request packet REQ is delayed by waiting for the other packet PKT-B3 currently transmitting, and the retransmission data packet PKT-A2 is delayed by the wait regarding the transmission of the other packet PKT-A4 currently transmitting. For this reason, the capacity of the buffer 97 increases, and packet delays also increase with this comparison example.

### Embodiments

According to the embodiment, multiple data regions and multiple stuff regions are allocated in a frame, in which a portion of a packet is stored in each data region, and the frame is transmitted with the retransmission request packet or the retransmission data packet that is contained in at least one stuff region, which enables the retransmission of packets with low delay.

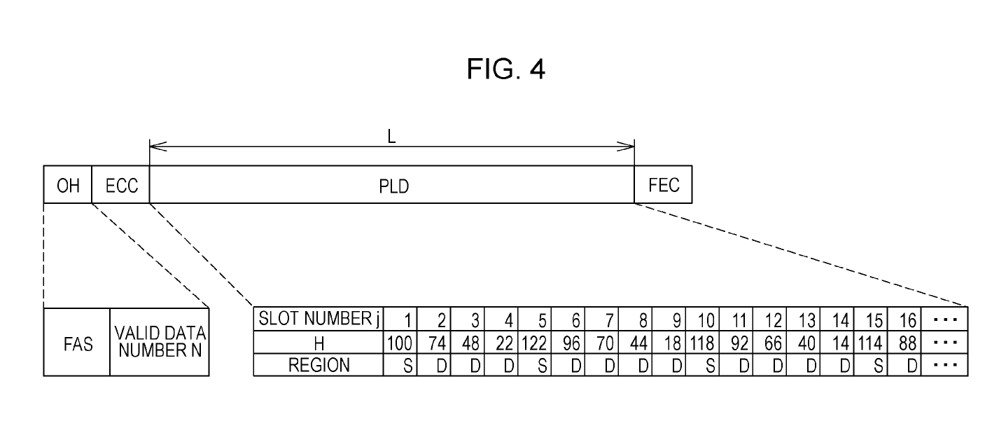

FIG. 4 is a configuration diagram illustrating an example of a frame. The frame includes overhead (OH), Error Correcting Code (ECC), the payload (PLD), and an FEC.

The overhead OH includes a Frame Alignment Signal (FAS) and a valid data number N. The FAS is one bit of data, for example, and is used for the synchronization processing of frames. The data pattern of the FAS is not limited as long as individual frames may be identified.

The valid data number N is 7 bits of data, and represents the number of data regions D mapped in the payload PLD. The ECC is the error correction encoding for correcting errors in the overhead OH.

The FEC is the error correction encoding for correcting errors in the payload PLD, and has an amount of that does not have any effect on delay. In order to reduce the amount of data in a frame, an arrangement may be made where the FEC is not implemented.

Multiple data regions D (may be referred to as a first region and a third region) and multiple stuff regions S (may be referred to as a second region and a fourth region) are allocated in the payload PLD. The data regions D contain a portion of a packet, and the stuff regions S contain the retransmission request packet REQ or the retransmission data packet.

The multiple data regions D and the multiple stuff regions S are allocated, for example, based on the Generic Mapping Procedure (GMP) specified in the ITU-T Recommendation G.709, that is to say, the sigma-delta mapping method. The payload PLD includes multiple slots obtained by dividing the whole region into specific data units. Each slot is given a slot number j, in which the data region D or the stuff region S is allocated to each slot number j.

H=(j×N)mod L Expression 1

H<N Expression 2

H≧N Expression 3

The allocation for each slot (either the data region D or the stuff region S) is determined by calculating the value H in Expression 1 for each slot number j. In Expression 1, the variable L is the total number of slots including the payload PLD (that is to say, the data number), and the variable N is the aforementioned valid data number. Mod represents the remainder from division.

When the conditions for the aforementioned Expression 2 are satisfied, each slot is allocated with the data region D, and when the conditions for the aforementioned Expression 3 are satisfied, each slot is allocated with the stuff region S. For example, if the total slot number L is 126, and the valid data number N is 100, then H will equal 100 when calculating Expression 1 and the slot number j equals 1, which satisfies Expression 3, and the stuff region S will be allocated. H will equal 74 when calculating Expression 1 and the slot number j equals 2, which satisfies Expression 2, and the data region D will be allocated.

In this way, when the multiple data regions D and the multiple stuff regions S are allocated, the data regions D and the stuff regions S may be dispersed within the payload, which enables the retransmission request packet REQ or the retransmission data packet to be contained in the stuff regions S even while a frame is being transmitted. As a portion of a packet is contained in each data region D, the retransmission request packet REQ or the retransmission data packet may be contained in the stuff regions S so as to be allocated to other packets currently being transmitted. For this reason, the retransmission request packet REQ and the retransmission data packet are transmitted without waiting for the transmission of other packets to finish.

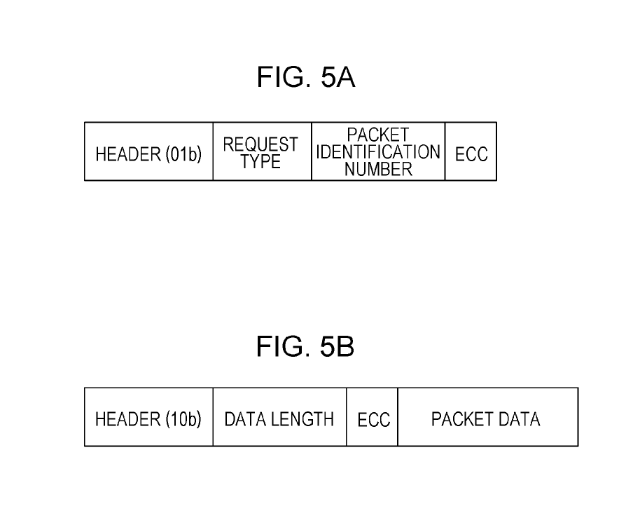

FIGS. 5A and 5B are configuration diagrams illustrating example packets, in which FIG. 5A illustrates a retransmission request packet and FIG. 5B illustrates a retransmission data packet. The retransmission request packet and the retransmission data packet include two-bit headers. The value of the retransmission request packet header is 01b, and the value of the retransmission request packet header is 10b. As a result, the retransmission request packet and the retransmission data packet may be identified. The “b” added to these values represents that the numbers are binary numbers.

The retransmission request packet includes a header, a request type, a packet identification number (identification number), and an ECC. The request type represents an identification of the content of the requested data. Examples of the request types include data for only the retransmission data packet, data for the retransmission data packet including the error correction encoding, and the data for only the error correction encoding of the retransmission data packet. Other examples of the request types include cases when the data for only the error correction encoding of the retransmission data packet is selected, in which the errors in the packet are of several bits, and error correction is enabled by error correction encoding such as parity. Hereinafter, the description will refer to the retransmitted data as the “retransmission data packet” for any of the aforementioned request types.

The packet identification number is an identification number added to the packet for which retransmission was requested. The packet identification number specifies the packet for which retransmission was requested. The ECC is an error correction encoding for correcting errors in the request type and the packet identification number. An arrangement may be made where ECC is not implemented.

The retransmission data packet also includes a header, the data length, an ECC, and the packet data. The data length represents the amount of data in the packet. The ECC is the error correction encoding for correcting errors in the data length. An arrangement may be made in which ECC is not implemented.

The packet data is the data of the retransmission data packet. When the data for the retransmission data packet with error correction encoding added is selected as the request type for the retransmission request packet, this error correction encoding is also included in the packet data in addition to the data for the retransmission data packet. When the data for only the error correction encoding is selected as the request type for the retransmission request packet, only this error correction encoding is included in the packet data. The retransmission data packet may be contained in one stuff region S, or may be divided and contained in multiple stuff regions S.

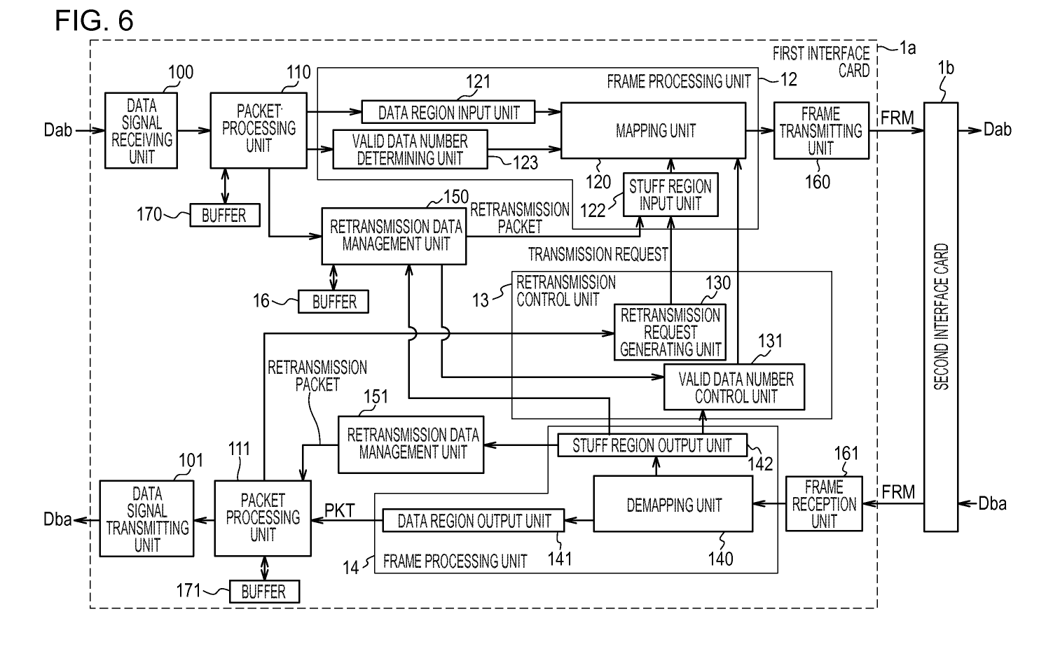

FIG. 6 is a configuration diagram of a communication device related to an embodiment. More specifically, FIG. 6 illustrates the configuration of an embodiment of the aforementioned interface card 1.

FIG. 6 illustrates a communication system including a first interface card 1a (may be referred to as a first communication device) and a second interface card 1b (may be referred to as a second communication device). The illustration of the switch card 3 arranged between the first interface card 1a and the second interface card 1b is omitted from FIG. 6.

Hereinafter, the description describes a case in which errors are detected in packets transmitted by the first interface card 1a to the second interface card 1b, and the second interface card 1b transmits a retransmission request packet to the first interface card 1a. Only the configuration of the first interface card 1a is illustrated in FIG. 6, but the configuration of the second interface card 1b is the same as that of the first interface card 1a.

The first interface card 1a includes a data signal receiving unit 100, a transmitting packet processing unit (corresponding to a generating unit) 110, a frame processing unit 12, a retransmission data management unit 150, a retransmission control unit 13, and a frame transmitting unit (corresponding to a transmitting unit) 160. The frame processing unit 12 includes a mapping unit 120, a data region input unit 121, a stuff region input unit 122, and a valid data number determining unit 123. The retransmission control unit 13 includes a retransmission request generating unit 130 and a valid data number control unit 131.

The first interface card 1a further includes a data signal transmitting unit 101, a received packet processing unit (corresponding to a detecting unit) 111, a frame processing unit 14, a retransmission data management unit 151, buffers 16, 170, and 171, and a frame receiving unit (corresponding to a receiving unit) 161. The frame processing unit 14 includes a demapping unit 140, a data region output unit 141, and a stuff region output unit 142.

First, the processing for the first interface card 1a to transmit a packet to the second interface card 1b when the processing to retransmit a packet is not occurring will be described. The data signal receiving unit 100 receives the data signal Dab (data signal Dba for the second interface card 1b, hereinafter the same) from the transmission paths #1 through #n.

The packet processing unit 110 converts the data signal Dab into packets at a specific rate, and outputs these packets to the frame processing unit 12. For example, the data signal Dab is divided and encapsulated into fixed-length packets several hundred bytes in size.

The packet processing unit 110 adds an individual packet identification number to each packet. The packet identification number is added to the header portion, for example. The packet identification number may be a repeating number between 0 through 15, for example, as it is sufficient to identify packets in a frame during the reception of a few frames at a time.

The packet processing unit 110 prepares for the request of the retransmission processing and stores packets in the buffer 170. When the retransmission processing is requested, the packet processing unit 110 stores packets in the buffer 170 as the output rate of packets to the frame processing unit 12 is slowed.

The packet processing unit 110 outputs the same packet to the retransmission data management unit 150 when outputting packets to the transmission frame processing unit 12. The retransmission data management unit 150 prepares for the retransmission processing, and stores packets input from the packet processing unit 110 into the buffer 16.

As previously described, when the packet retransmission processing is requested, the retransmission data management unit 150 reads packets from the buffer 16 and outputs these packets to the transmission frame processing unit 12. At this time, the retransmission data management unit 150 selects the packet to retransmit from the buffer 16 based on the packet identification number included in the instruction from the retransmission control unit 13.

The valid data number determining unit 123 detects the data signal Dab input from the packet processing unit 110, and determines the aforementioned valid data number N based on the average value. A byte counter counting the number of bytes in the data signal Dab is an example of the method to detect the average value of the communication rate.

The communication rate between the first interface card 1a and the second interface card 1b is set higher than the communication rate for the data signals Dab input by the packet processing unit 110 to include the bandwidth used for retransmitting packets. For this reason, the valid data number determining unit 123 determines the valid data number N so that the entire payload PLD in the frame is not filled with data regions D when the packet retransmission processing is not occurring. That is to say, the valid data number N is determined to be less than the slot number L for the payload PLD to ensure bandwidth used for the packet retransmission processing. The valid data number determining unit 123 outputs the determined valid data number N to the mapping unit 120.

The mapping unit 120 generates the frame, and maps the interior of the frame according to the mapping method described with reference to FIG. 4. That is to say, the mapping unit 120 allocates multiple data regions D and multiple stuff regions S inside the frame.

The mapping unit 120 obtains the valid data number N from the valid data number determining unit 123 when the packet retransmission processing is not occurring. Conversely, the mapping unit 120 obtains the valid data number N from the retransmission control unit 13 when the packet retransmission processing has occurred. The mapping unit 120 maps the frame based on the obtained valid data number N and the slot number L for the payload PLD. The slot number L for the payload PLD was previously given to the mapping unit 120 as a fixed value.

The mapping unit 120 inputs the packet from the packet processing unit 110 via the data region input unit 121. The mapping unit 120 contains portions of the packet in the multiple data regions D. The mapping unit 120 may contain information representing a boundary unit such as a delimiter in a data region D corresponding to the packet boundary from among the multiple data regions D, for example, to determine individual packets at the receiving side. The mapping unit 120 may add error detection coding such as a parity bit to the end of each packet, which may be contained in the data region.

The mapping unit 120 contains data values of zeroes in the multiple stuff regions S when the retransmission processing is not occurring. This zero-value data is used for padding of the stuff regions S not used for packet retransmission processing, and is discarded by the second interface card 1b.

As will be described, the mapping unit 120 inputs the retransmission data packet from the retransmission data management unit 150 via the stuff region input unit 122 when the retransmission processing is occurring. In this case, the mapping unit 120 contains the retransmission data packet in at least one of the multiple stuff regions S.

When errors are detected in packets received from the first interface card 1a at the second interface card 1b, the mapping unit 120 in the first interface card 1a inputs the retransmission request packet from the retransmission control unit 13 via the stuff region input unit 122. In this case, the mapping unit 120 contains the retransmission request packet in at least one of the multiple stuff regions S.

The mapping unit 120 outputs the frame to the frame transmitting unit 160. The frame transmitting unit 160 converts a frame FRM input from the mapping unit 120 into an optical signal, for example, and transmits this to the second interface card 1b. At this time, the frame transmitting unit 160 transmits the frame at a communication rate faster than the communication rate for the data signal Dab. As a result, the bandwidth between the interface cards 1a and 1b is set wider than the bandwidth for the data signal Dab, and the excess bandwidth is to be used for the packet retransmission processing.

Next, the transmission processing of the retransmission request packet REQ in the second interface card 1b will be described using configuration elements of the first interface card 1a illustrated in FIG. 6. The frame FRM containing packets, transmitted from the frame transmitting unit 160 in the first interface card 1a is received by the frame reception unit 161. The frame reception unit 161 converts the frame FRM into electrical signals, for example, and outputs this to the demapping unit 140. The frame reception unit 161 may detect errors in the packets contained in the frame FRM.

The demapping unit 140 searches the overhead OH in the frame FRM, and corrects errors by the ECC in the frame FRM when errors are detected. The demapping unit 140 searches the payload PLD in the frame FRM, and corrects errors by the FEC in the frame FRM when errors are detected. The demapping unit 140 may add information to the payload PLD representing that error correction is not possible when error correction of the payload PLD is not possible by the FEC.

The demapping unit 140 extracts the multiple data regions D and the multiple stuff regions S from the payload PLD of the frame FRM based on the valid data number N included in the overhead OH. That is to say, the demapping unit 140 demaps the multiple data regions D and the multiple stuff regions S.

The demapping unit 140 outputs zero-value data contained in multiple stuff regions S to the stuff region output unit 142. The stuff region output unit 142 discards the zero-value data contained in the multiple stuff regions S.

The demapping unit 140 outputs the portions of packets contained in the multiple data regions D to the packet processing unit 111 via the data region output unit 141. The packet processing unit 111 generates the packets contained in the frame, and detects errors in packets by performing a search.

The packet processing unit 111 stores the search results in the buffer 171 for only a specific amount of time when there were no errors detected in the packet. As a result, the data signal Dab may be restored correctly even when the packet retransmission processing occurs due to errors detected after waiting for a normal packet for at least the time for the retransmission processing. The packet processing unit 111 may detect packet errors based on information representing that error correction is not possible, which was added to the payload PLD by the demapping unit 140, or may detect packet errors by a parity bit added to the packet.

The packet processing unit 111 notifies the retransmission control unit 13 of the packet identification number of the packet for which errors were detected when errors are detected in a packet. The packet processing unit 111 normally collects the packet identification numbers, and corrects the packet identification number to a correct packet identification number when the packet identification number is incorrect. For example, when “1”, “2”, “3”, and “9” are continuously and sequentially collected as the packet identification numbers, the number sequence is not correct with regard to the final “9” and it is clear that this is an error, so the packet identification number is corrected to “4”. The packet processing unit 111 notifies the retransmission control unit 13 of the type of information requested for retransmission (“request types” in FIG. 5A) in accordance with the packet search results.

The retransmission request generating unit 130 generates the retransmission request packet REQ illustrated in FIG. 5A based on the request type and the packet identification number notified by the packet processing unit 111. The retransmission request generating unit 130 outputs the generated retransmission request packet REQ to the mapping unit 120 via the stuff region input unit 122.

The mapping unit 120 contains the retransmission request packet REQ in at least one of the multiple stuff regions S allocated to the frame currently being processed. The process to contain the retransmission request packet REQ is possible even during the transmission of the current frame by the frame transmitting unit 160 if there is a stuff region S for which the containing timing is securable. As a result, the retransmission request packet REQ is transmitted to the first interface card 1a without waiting for other packets currently being transmitted, which reduces delay. The retransmission request packet REQ may be contained over multiple stuff regions S.

Next, the retransmission processing in the first interface card 1a will be described. The frame FRM containing the retransmission request packet REQ, transmitted from the frame transmitting unit 160 in the second interface card 1b is received by the frame reception unit 161. The frame reception unit 161 outputs the frame FRM to the demapping unit 140. The demapping unit 140 outputs the portions of packets contained in the multiple data regions D to the packet processing unit 111 via the data region output unit 141.

The demapping unit 140 outputs the retransmission request packet REQ contained in the multiple stuff regions S and zero-value data to the stuff region output unit 142. The stuff region output unit 142 determines the retransmission request packet REQ by the header illustrated in FIG. 5A, and outputs the retransmission request packet REQ to the valid data number control unit 131 and the retransmission data management unit 150. The zero-value data is discarded by the stuff region output unit 142.

The retransmission data management unit 150 reads the corresponding packet from the buffer 16 based on the packet identification number included in the retransmission request packet REQ when the retransmission request packet REQ is input.

The retransmission data management unit 150 generates the retransmission data packet from the read packet based on the request type (refer to FIG. 5A) included in the retransmission request packet REQ. That is to say, the retransmission data management unit 150 selects and generates one type of data depending on the request type, the data for the retransmission data packet, the data for the retransmission data packet with the error correction encoding added, or the error correction encoding data for the retransmission data packet. As previously described, the description refers to all of these data types as the “retransmission data packet” for uniformity purposes regardless of the request type. The generated retransmission data packet is input into the mapping unit 120 via the stuff region input unit 122.

The retransmission data management unit 150 counts an untransmitted data number K of the retransmission data packet every time the mapping unit 120 performs a mapping, and notifies the valid data number control unit 131 of this. The data number K is the value of the untransmitted data amount of the retransmission data packet converted into the slot number within the payload PLD.

The mapping unit 120 divides the retransmission data packet input from the stuff region input unit 122, and stores this into the multiple stuff regions S allocated in the frame currently being processed. The process to contain the retransmission data packet is possible even during the transmission of the current frame by the frame transmitting unit 160 if there is a stuff region S for which the containing timing is securable. As a result, the retransmission data packet is transmitted to the second interface card 1b without waiting for other packets currently being transmitted, which reduces delay.

The valid data number control unit 131 determines the valid data number N when the retransmission request packet REQ is input, and notifies the mapping unit 120 of this. At this time, the mapping unit 120 performs the mapping using the valid data number N instructed by the valid data number control unit 131 instead of the valid data number N determined by the valid data number determining unit 123. The determined valid data number N is applied from the next frame mapped after the frame currently undergoing the mapping processing.

The valid data number control unit 131 sets the valid data number N to zero when the data number K for the retransmission data packet notified from the retransmission data management unit 150 is at least the slot number L for the payload PLD in the frame FRM. As a result, the mapping unit 120 allocates only the stuff regions S in the frame so that the entire payload PLD is used for the transmission of the retransmission data packet.

In this way, the transmission frame processing unit 12 extends the multiple stuff regions S in accordance with the retransmission request packet REQ. As a result, delays in the retransmission data packet are reduced as the bandwidth used for the retransmission processing is expanded.

Conversely, the valid data number control unit 131 sets the valid data number N equal to L-K when the data number K for the retransmission data packet notified from the retransmission data management unit 150 is less than the slot number L for the payload PLD in the frame FRM. As a result, the mapping unit 120 allocates the data regions D in the frame so that the remaining portion of the payload PLD is used to transmit other packets during the packet retransmission processing. As a result, the unused stuff regions S, that is to say, the stuff regions S containing zero-value data, are not generated, which reduces wasted bandwidth.

In this way, the transmission frame processing unit 12 allocates the multiple stuff regions S depending on the amount of untransmitted data for the retransmission data packet. Therefore, the usage efficiency of bandwidth is improved.

When the packet retransmission processing finishes, the mapping unit 120 again maps the frame FRM in accordance with the valid data number N determined by the valid data number determining unit 123. At this time, the valid data number control unit 131 is notified by the retransmission data management unit 150 that the packet retransmission processing is finished, and stops control in accordance with this notification.

The valid data number determining unit 123 is notified of the total packet data amount stored in the buffer 170 from the packet processing unit 110. The valid data number determining unit 123 determines that the valid data number N is the same value as the slot number L of the payload PLD when the total packet data amount stored in the buffer 170 is more than a predetermined threshold Th. As a result, the mapping unit 120 allocates only the data regions D in the frame so that the entire payload PLD is used for the transmission.

In this way, the transmission frame processing unit 12 extends the multiple data regions D after the frame transmitting unit 160 transmits the frame FRM containing the retransmission data packet. Therefore, the packets stored in the buffer 170 for the purpose of the packet retransmission processing use a wide bandwidth to be transmitted with low delay. As a result, bandwidth constrictions due to the packet retransmission processing are removed. The valid data number determining unit 123 determines the valid data number N based on the average value for the communication rate of the data signal Dab when the total packet data amount stored in the buffer 170 is equal to or less than the predetermined threshold Th.

The valid data number N determined by either the valid data number determining unit 123 or the valid data number control unit 131 is applied from the next frame after the frame currently being mapped, as previously described. Therefore, the frame length is preferably shorter than the packet length so that the valid data number N is applied as quickly as possible. That is to say, the frame length may be determined so that packets may be divided and contained within multiple frames FRM.

Next, the reception processing of the retransmission data packet in the second interface card 1b will be described using configuration elements of the first interface card 1a illustrated in FIG. 6. The demapping unit 140 outputs the portions of packets contained in the multiple data regions D to the packet processing unit 111 via the data region output unit 141. The demapping unit 140 outputs the portions of the retransmission data packet contained in the multiple stuff regions S to the stuff region output unit 142.

The stuff region output unit 142 identifies the retransmission data packet by referencing the header (refer to FIG. 5B). The stuff region output unit 142 outputs the portions of the retransmission data packet contained in the multiple stuff regions S to the retransmission data management unit 151. At this time, the stuff region output unit 142 obtains the data amount of the retransmission data packet from the data length (refer to FIG. 5B), and continues to output to the retransmission data management unit 151 until all data for the retransmission data packet is finished being output. Here, the retransmission data packet may be contained over multiple frames. The stuff region output unit 142 corrects errors by the ECC when there are errors in the data length.

The retransmission data management unit 151 regenerates the retransmission data packet based on the data input from the stuff region output unit 142. The retransmission data management unit 151 outputs the regenerated retransmission data packet to the packet processing unit 111.

The packet processing unit 111 replaces the packet for which errors were detected with the retransmission data packet. Here, the packet processing unit 111 corrects errors in the retransmission data packet using the error correction encoding when the error correction encoding is added to the retransmission data packet, depending on the request type. The packet processing unit 111 corrects packets for which errors were detected using the error correction encoding when only the error correction encoding is input as the retransmission data packet.

The packet processing unit 111 restores the data signal Dab (the data signal Dba in the case of the first interface card 1a, hereinafter the same) from the retransmission data packet input from the retransmission data management unit 151 (or the packet for which errors were corrected) and the other packets stored in the buffer 171. The packet processing unit 111 outputs the restored data signal Dab to the data signal transmitting unit 101.

The data signal transmitting unit 101 transmits the data signal Dab input from the packet processing unit 111 out the transmission paths #1 through #n. The communication rate of the data signal transmitting unit 101 is slower than the receiving rate of the frame reception unit 161.

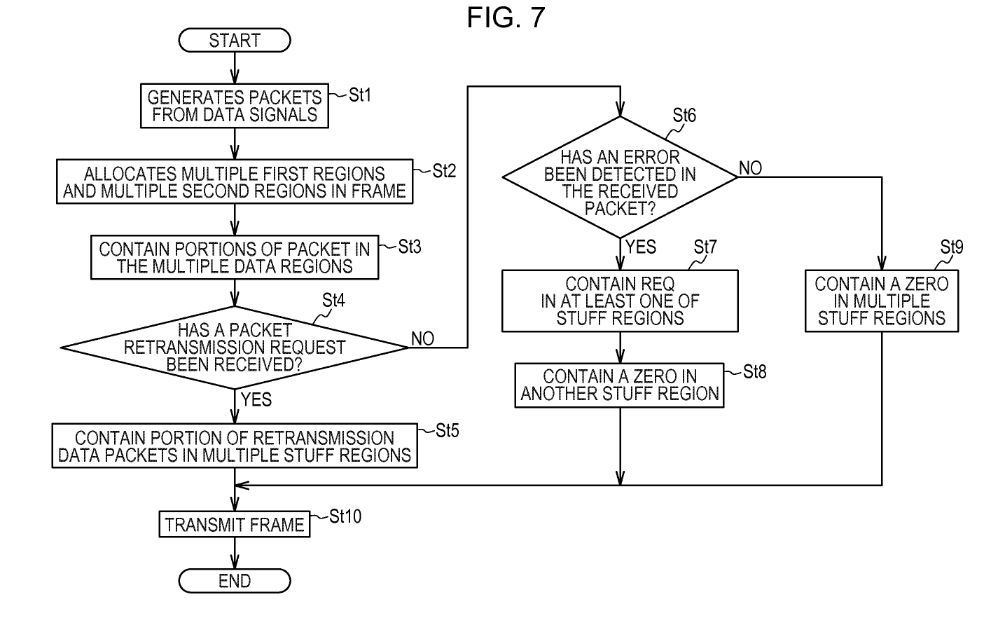

Next, the communication method related to the embodiment will be described predicated on the configurations of the previously described interface cards 1a and 1b. FIG. 7 is a flowchart of the transmission processing of a frame.

First, the packet processing unit 110 generates packets from the data signal Dab continuously input (operation St1). Next, the mapping unit 120 generates the frame, and allocates the multiple data regions D and the multiple stuff regions S within the frame (operation St2). Regarding the allocation processing when the packet retransmission processing is not occurring, the valid data number determining unit 123 performs the allocation according to the valid data number N determined by the valid data number determining unit 123, and performs the allocation according to the valid data number N determined by the valid data number control unit 131 when the packet retransmission processing is occurring.

Next, the mapping unit 120 contains portions of packets in the multiple data regions D (operation St3). At this time, the packet is preferably contained over multiple frames.

Next, the mapping unit 120 contains portions of the retransmission data packet in multiple stuff regions S when the retransmission request packet REQ is received by the frame reception unit 161 (Yes for operation St4) (operation St5).

When the retransmission request packet REQ is not received (No for operation St4), and the packet processing unit 111 detects errors in the packet (Yes for operation St6), the mapping unit 120 contains the retransmission request packet REQ in at least one of stuff regions S (operation St7). At this time, the mapping unit 120 contains zero-value data in other stuff regions S (operation St8).

When the conditions for the aforementioned operations St4 and St6 are not satisfied (No for operations St4 and St6), the mapping unit 120 contains zero-value data in the multiple stuff regions S (operation St9). The frame transmitting unit 160 transmits the frame (operation St10). In this way, the transmission processing of the frame is performed.

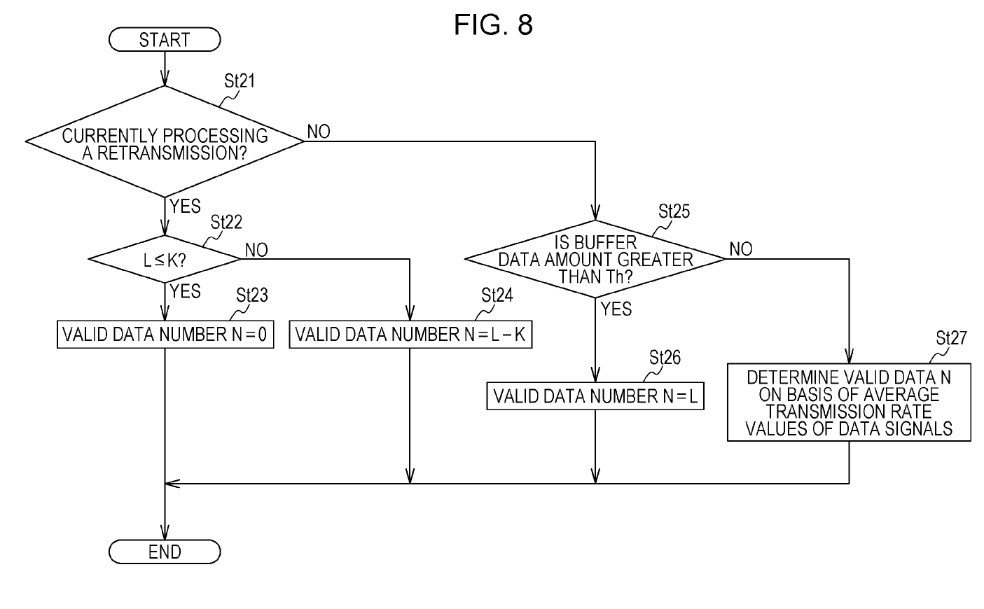

FIG. 8 is a flowchart of the control processing of valid data number N. During the retransmission processing (Yes for operation St21), the valid data number control unit 131 compares the untransmitted data number K of the retransmission data packet and the slot number L for the payload PLD (operation St22). When comparison results indicate that the untransmitted data number K of the retransmission data packet is the same or larger than the slot number L for the payload PLD (Yes for operation St22), the valid data number control unit 131 determines that the valid data number N is equal to zero (operation St23). As a result, the bandwidth used to transmit the retransmission data packet is extended, and the delay in the retransmission data packet is reduced.

Conversely, when the untransmitted data number K of the retransmission data packet is less than the slot number L for the payload PLD (No for operation St22), the valid data number control unit 131 determines that the valid data number N is equal to L-K (operation St24). As a result, the remaining bandwidth not used for the transmission of the retransmission data packet is used to transmit other packets, which improves bandwidth usage efficiency.

When the retransmission processing is not occurring (No for operation St21), the valid data number determining unit 123 compares the amount of data in the buffer 170 and the predetermined threshold Th (operation St25). When amount of data in the buffer 170 is more than the predetermined threshold Th (Yes for operation St25), the valid data number determining unit 123 determines that the valid data number N is equal to L (operation St26). As a result, the bandwidth used to transmit packets is extended for the packet retransmission processing, and so packets stored in the buffer 170 are transmitted with low delay.

Conversely, when the amount of data in the buffer 170 is less than or equal to the predetermined threshold Th (No for operation St25), the valid data number determining unit 123 determines the valid data number N based on the average value of the communication rate for the data signal Dab input into the packet processing unit 110 (operation St27). In this way, the control processing of the valid data number N is performed.

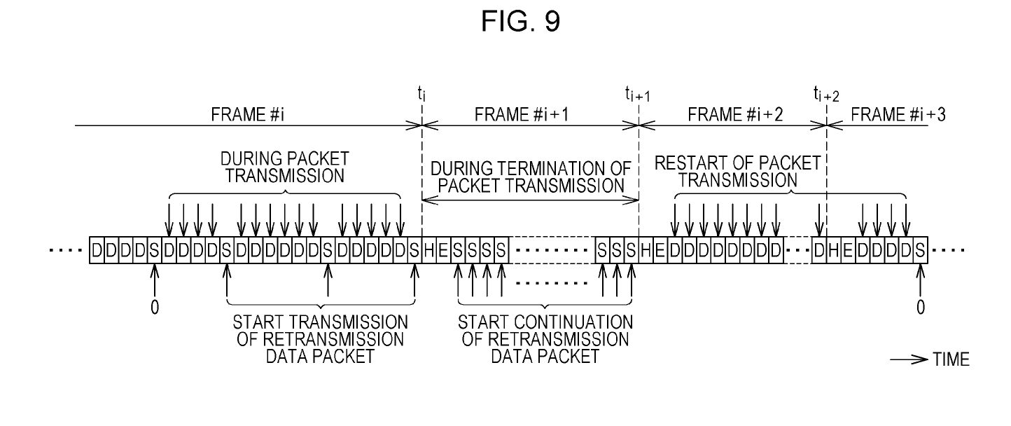

FIG. 9 is a time chart illustrating an example of the transmission processing of a frame. FIG. 9 illustrates a case in which frames #i through i+3 are transmitted sequentially. In FIG. 9, “H” represents the overhead OH illustrated in FIG. 4, and “E” represents the ECC illustrated in FIG. 4. “D” represents the data regions D, and “S” represents the stuff regions S.

When the retransmission request packet REQ is received, the first interface card 1a contains portions of packets in each data region D for the frame #i while also containing portions of the retransmission data packet into each stuff region S, and then transmits frame #i.

The first interface card 1a transmits the next frame #i+1 at a timing ti. At this time, the untransmitted data number K of the retransmission data packet is presumed to be the same as the slot number L for the payload PLD3, and so the valid data number control unit 131 determines the valid data number N to be equal to zero.

The value of the valid data number N being zero is applied to frame #i+1, and the stuff regions S are allocated to all of the payload PLD for this frame. For this reason during the transmission period of frame #i+1, the first interface card 1a stops transmitting packets, and then continuously transmits the retransmission data packet using the entire payload PLD.

The first interface card 1a transmits the next frame #i+2 at a timing tᵢ₊₁. At this time, the transmission of the retransmission data packet finishes, and the amount of data for packets stored in the buffer 170 is presumed to be more than the threshold Th, so the valid data number determining unit 123 determines the valid data number N to be equal to L.

The value of the valid data number N equal to L is applied to frame #i+2, and the data regions D are allocated to all of the payload PLD for this frame. For this reason during the transmission period of frame #i+2, the first interface card 1a restarts transmitting packets using the entire payload PLD. As a result, packets stored in the buffer 170 for the retransmission processing are transmitted, which removes bandwidth constrictions.

The first interface card 1a transmits the next frame #i+3 at a timing tᵢ₊₂. At this time, the amount of data for packets stored in the buffer 170 is presumed to be equal to or less than the threshold Th, so the valid data number determining unit 123 determines the valid data number N based on the average communication rate of the data signal Dab.

The valid data number N determined based on the average value for the communication rate of the data signal Dab is applied to frame #i+3. For this reason, the first interface card 1a contains portions of packets in each data region D of frame #i while also containing zero-value data in each stuff region S, and transmits frame #1+3.

In this way, the first interface card 1a changes the number of the data regions D and the stuff regions S allocated within the frame depending on conditions. That is to say, the bandwidth of data contained in the data regions D and the bandwidth for data contained in the stuff regions S actively changes.

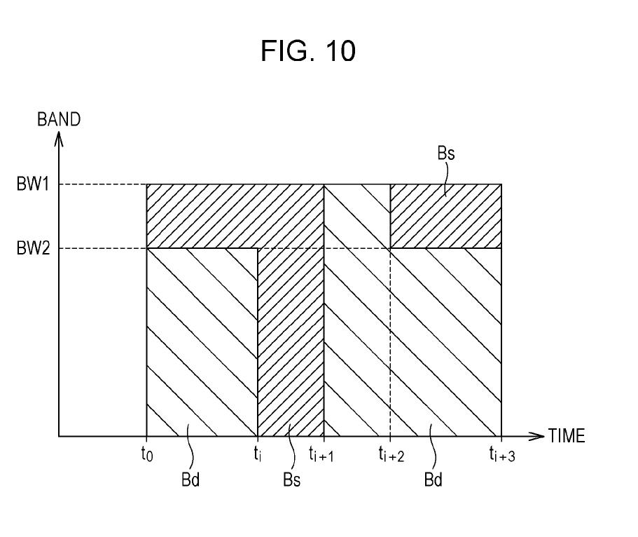

FIG. 10 is a graph illustrating an example of changes in bandwidths Bd and Bs for the data regions D and the stuff regions S. The content of FIG. 10 follows the example of the transmission processing illustrated in FIG. 9.

In FIG. 10, the vertical axis represents the bandwidth size of bandwidths Bd and Bs, and the horizontal axis represents time. A bandwidth BW1 is equivalent to all bandwidth for packet communication between the interface cards 1a and 1b, and a bandwidth BW2 (less than BW1) is equivalent to the bandwidth of the data signal Dab (or Dba) input into the packet processing unit 110.

At timings t₀ through tᵢ, the valid data number N is determined according to the average value of the communication rate for the data signal Dab, and so the bandwidth Bd for the data regions D is the bandwidth BW1, and the bandwidth Bs for the stuff regions S is remaining bandwidth of BW1-BW2. For this reason, the first interface card 1a may only transmit the retransmission data packet with a narrow bandwidth.

At timings t₁ through tᵢ₊₁, the valid data number N is equal to zero, and so the bandwidth Bd for the data regions D is zero, and the bandwidth Bs for the stuff regions S is the bandwidth BW1. For this reason, the first interface card 1a may transmit the retransmission data packet with a wide bandwidth.

At timings tᵢ₊₁ through tᵢ₊₂, the valid data number N is equal to the slot number L for the payload PLD, and so the bandwidth Bd for the data regions D is the bandwidth BW1, and the bandwidth Bs for the stuff regions S is zero. For this reason, the first interface card 1a may transmit the packets with a wide bandwidth.

Afterwards, at timings tᵢ₊₂ through timings tᵢ₊₃, the valid data number N is again determined according to the average value of the communication rate of the data signal Dab, and so the bandwidth Bd for the data regions D is the bandwidth BW1, and the bandwidth Bs for the stuff regions S is the remaining bandwidth of BW1-BW2. As a result, the bandwidth returns to the normal state.

In this way, not are packets and the retransmission data packet transmitted with low delay by actively controlling the bandwidths Bd and Bs for the data regions D and the stuff regions S, bandwidth usage efficiency is also improved.

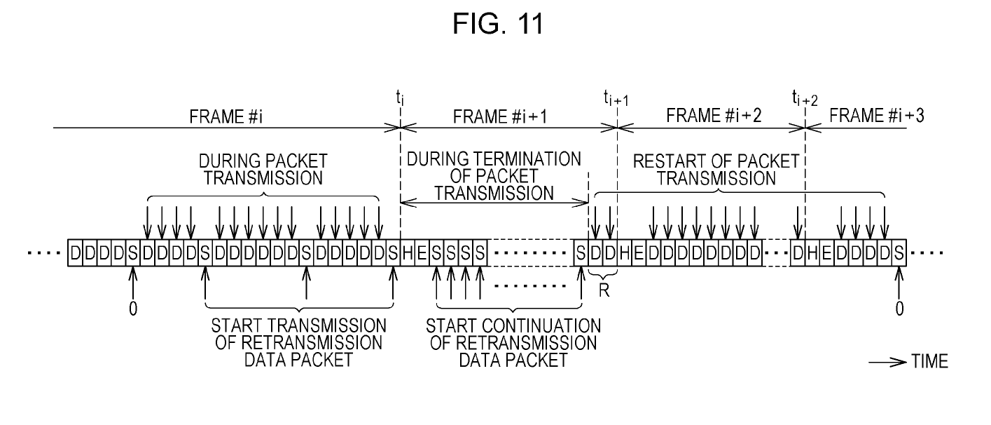

FIG. 11 is a time chart illustrating another example of the transmission processing of a frame. To understand a comparison with the example illustrated in FIG. 10, the example illustrated in FIG. 11 depicts a case in which the data number K for the retransmission data packet contained in frame #i+1 is smaller than the slot number L for the payload PLD, and so the valid data number N is determined to be equal to L-K.

In this case, the data regions D are allocated to a remaining portion R of the payload PLD for frame #i+1, which is used to transmit packets. For this reason, wasted bandwidth is reduced, and bandwidth usage efficiency is improved.

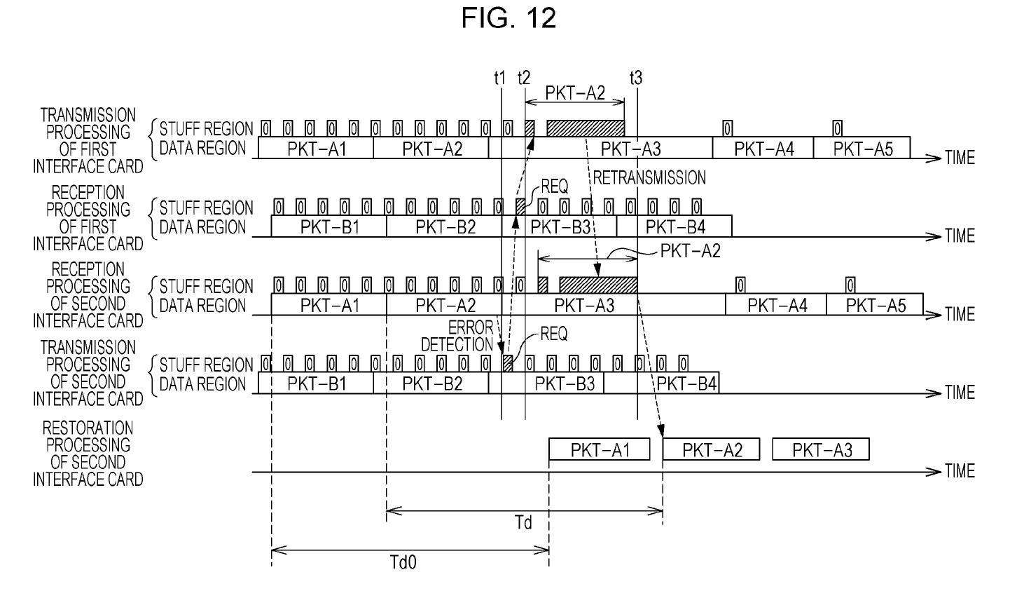

Next, the advantages of the embodiment described up to this point will be described in more detail. FIG. 12 is a time flowchart illustrating an example of timing of a transmission processing and a reception processing of packets related to an embodiment.

In FIG. 12, the packets transmitted from the first interface card is are labeled as “PKT-A1” through “PKT-A5” in the order they are transmitted. Packets transmitted from the second interface card 1b are labeled as “PKT-B1” through “PKT-B4” in the order they are transmitted.

FIG. 12 illustrates the timing in which an error in the packet PKT-A2 transmitted by the first interface card 1a is detected by the second interface card 1b, and the first interface card 1a retransmits the packet PKT-A2 in response to the retransmission request packet REQ. From the top of the page, FIG. 12 illustrates timings of the transmission processing and reception processing for the first interface card 1a, and the transmission processing, reception processing, and restoration processing for the second interface card 1b. Here, the contents of data (PKT-A1 and so on) in the data regions D and the stuff regions S are illustrated for each transmission processing and each reception processing. The content of stuff regions S labeled with a zero represents the zero-value data.

At a timing t1, the second interface card 1b detects an error in the packet PKT-A2 transmitted by the first interface card 1a. At the timing t1, the packet PKT-B3 is being transmitted, but the second interface card 1b contains the retransmission request packet REQ in the stuff regions S closest to the error detection timing t1 from among the multiple stuff regions S for the frame containing the packet PKT-B3.

For this reason, the retransmission request packet REQ is different than that of the comparison example illustrated in FIG. 3, and it is transmitted without having to wait for the transmission of the packet PKT-B3 to finish. Therefore, the retransmission request packet REQ is transmitted by the first interface card 1a with low delay.

At a timing t2, the first interface card 1a transmits the retransmission request packet REQ. At the timing t2, the packet PKT-A3 is being transmitted, but the first interface card 1a contains portions of the retransmission data packet PKT-A2 in the stuff regions S closest to the reception timing t2 from among the multiple stuff regions S for the frame containing the packet PKT-A3. The first interface card 1a allocates only the stuff regions S for the next frame (that is to say, extends the stuff regions), and contains the remaining portions of the retransmission data packet PKT-A2 in each stuff region S.

For this reason, the retransmission data packet PKT-A2 is different from that of the comparison example illustrated in FIG. 3, and it is transmitted without having to wait until the transmission of the packet PKT-A3 finishes. Therefore, the retransmission data packet PKT-A2 is transmitted by the second interface card 1b with low delay.

At the timing t3, the second interface card 1b receives the retransmission data packet PKT-A2. Afterwards, the first interface card 1a extends the data regions D in the frame to transmit the packets stored in the buffer 170 by the packet retransmission processing. As a result, packets PKT-A4 and PKT-A5 are transmitted by the second interface card 1b with low delay, and bandwidth constrictions are removed.

As previously described, the second interface card 1b stores the received packet PKT-A1 in the buffer 171 for a specific time Td0. Here, the time Td0 is longer than a delay time Td from the retransmission of the packet PKT-A2, as the time taken to retransmit packets from the first interface card 1a is included.

According to the present embodiment, approx. two packets worth of time is reduced over the comparison example, as may be understood by comparing the time Td0 and the time Td in FIGS. 3 and 12. For this reason, the capacity of the buffer 171 is also reduced. The example of communication between the interface cards 1a and 1b within the transmission device have been described up to this point, but the previously described content is not limited to this kind of communication within a device, and may also be applied to communication between independent communication devices.

As described up to this point, the communication device (interface card) 1a related to the embodiment includes the frame processing unit 12, the frame transmitting unit 160 for transmitting frames, and the frame reception unit 161 for receiving the retransmission request packet REQ for packets. The frame processing unit 12 allocates the multiple data regions D and the multiple stuff regions S in the frame, and contains portions of packets in the multiple data regions D. The frame processing unit 12 contains the retransmission data packet in at least one of the multiple stuff regions S in accordance with the retransmission request packet REQ received by the frame reception unit 161.

According to the previously described configuration, the frame processing unit 12 allocates the multiple data regions D and the multiple stuff regions S in the frame, which enables the data regions D and the stuff regions S to be dispersed within the frame. For this reason, the retransmission data packet may be contained with the stuff regions S even when a frame is being transmitted.

As a portion of a packet is contained in each data region D, the retransmission data packet may be contained in the stuff regions S so as to be allocated to other packets currently being transmitted. For this reason, the retransmission data packet is transmitted without having to wait for other packets to be transmitted. Therefore, the communication device according to the embodiment may retransmit packets with low delay.

The communication device (interface card) 1b related to the other embodiment includes the frame processing unit 12, the frame transmitting unit 160 for transmitting frames, and the frame reception unit 161 for receiving frames from other devices. The communication device 1b further includes the packet processing unit 111 for detecting errors in packets contained in frames received by the frame reception unit 161.

The frame processing unit 12 allocates the multiple data regions D and the multiple stuff regions S in the frame, and contains portions of packets in the multiple data regions D. When errors are detected in packets by the packet processing unit 111, the frame processing unit 12 contains the retransmission request packet REQ for this packet in at least one of the multiple stuff regions S.

According to the previously described configuration, the frame processing unit 12 allocates the multiple data regions D and the multiple stuff regions S in the frame, which enables the data regions D and the stuff regions S to be dispersed within the frame. For this reason, the retransmission request packet REQ may be contained in the stuff regions S even when a frame is being transmitted.

As a portion of a packet is contained in each data region D, the retransmission request packet REQ may be contained in the stuff regions S so as to be allocated to other packets currently being transmitted. For this reason, the retransmission request packet REQ is transmitted without having to wait for other packets to be transmitted. Therefore, the communication device according to the other embodiment may retransmit packets with low delay.

The communication system related to the embodiment includes the first communication device 1a and the second communication device 1b. The communication device 1a includes the frame processing unit 12, the frame transmitting unit 160, and the frame reception unit 161.

The frame processing unit 12 allocates the multiple data regions D and the multiple stuff regions S in the frame, and contains portions of packets in the multiple data regions D. The frame transmitting unit 160 transmits frames to the second communication device 1b. The frame reception unit 161 receives the retransmission request for packets from the second communication device 1b. The frame processing unit 12 contains the retransmission data packet in at least one of the multiple stuff regions S in accordance with the retransmission request packet REQ received by the frame reception unit 161.

The communication device 1b includes the frame reception unit 161, the packet processing unit 111, the frame processing unit 12, and the frame transmitting unit 160. The frame reception unit 161 receives frames from the first communication device 1a. The packet processing unit 111 detects errors in packets contained within the multiple data regions D in the frame received by the frame reception unit 161.

The frame processing unit 12 allocates the multiple data regions D and the multiple stuff regions S in the frame, and contains portions of packets in the multiple stuff regions S. The frame transmitting unit 160 transmits frames to the first communication device 1a. When errors are detected in packets by the packet processing unit 111, the frame processing unit 12 contains the retransmission request packet REQ for this packet in at least one of the multiple stuff regions S.

The communication system according to the embodiment includes similar configurations to that of the communication devices 1a and 1b related to the embodiment, and so also achieves usage advantages similar to the previously described content.

The communication method according to the embodiment includes the following processes (1) and (2).

(1) The frame processing unit 12 allocates the multiple data regions D and the multiple stuff regions S in the frame, contains portions of packets in the multiple data regions D, and transmits the frame.

(2) The retransmission data packet is contained in at least one of the multiple stuff regions in accordance with the packet retransmission request.

The communication method according to the embodiment includes similar configurations to that of the communication device 1a related to the embodiment, and so also achieves usage advantages similar to the previously described content.

The content of the present technology has been described in detail with reference to the preferred embodiments, but it has to be understood that various modifications could be made by those skilled or experienced in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a frame processing unit configured to allocate a plurality of first regions and a plurality of second regions in a frame, and contain portions of a packet in the plurality of first regions;
a transmitting unit configured to transmit the frame; and
a receiving unit configured to receive a retransmission request for the packet,
wherein the frame processing unit contains a retransmission data packet in at least one of the plurality of second regions in accordance with the retransmission request received by the receiving unit.

2. The communication device according to claim 1,
wherein the frame processing unit extends the plurality of second regions in accordance with the retransmission request.

3. The communication device according to claim 2,
wherein the frame processing unit allocates the plurality of second regions for the retransmission data packet in accordance with the amount of untransmitted data of the retransmission data packet.

4. The communication device according to claim 1,
wherein the frame processing unit extends the plurality of first regions after the frame containing the retransmission data packet is transmitted by the transmitting unit.

5. The communication device according to claim 1,
wherein the packet is divided and contained in a plurality of frames.

6. The communication device according to claim 1,
wherein the frame processing unit contains the retransmission data packet and correction encoding for correcting errors in the retransmission data packet in at least one of the plurality of second regions.

7. The communication device according to claim 1,
wherein the packet includes an individual identification number, the retransmission request includes the identification number corresponding to the packet to be retransmitted, and the frame processing unit contains the retransmission data packet corresponding to the identification number included in the retransmission request in at least one of the plurality of second regions.

8. The communication device according to claim 1, further comprising:
a generating unit configured to generate the packet from a data signal continuously input;
wherein the transmitting unit transmits the frame at a communication speed faster than the communication speed of the data signal.

9. The communication device according to claim 1, further comprising:
a detecting unit configured to detect errors in packets contained in frames received by the receiving unit,
wherein the frame processing unit allocates a plurality of third regions and a plurality of fourth regions in the frame, contains portions of the packet in the plurality of third regions, and contains the retransmission request for the packet in at least one of the plurality of fourth regions when an error is detected in the packet by the detecting unit.

10. A communication system comprising:
a first communication device; and
a second communication device configured to receive a first frame from the first communication device and transmit a second frame to the first communication device;
wherein the first communication device includes;
a first frame processing unit configured to allocate a plurality of first regions and a plurality of second regions in the first frame, and contain portions of a packet in the plurality of first regions;
a first transmitting unit configured to transmit the first frame to the second communication device; and
a first receiving unit configured to receive retransmission requests for the packet from the second communication device,
the first frame processing unit containing a retransmission data packet in at least one of the plurality of second regions in accordance with the retransmission request received by the first receiving unit, and
wherein the second communication device includes;
a second receiving unit configured to receive the first frame from the first communication device;
a detecting unit configured to detect errors in packets contained in the plurality of first regions in the first frame received by the second receiving unit,
a second frame processing unit configured to allocate a plurality of third regions and a plurality of fourth regions in a second frame, and to contain portions of a packet in the plurality of third regions; and
a second transmitting unit configured to transmit the second frame to the first communication device,
the second frame processing unit containing a retransmission request for a packet in at least one of the plurality of fourth regions when an error is detected in the packet by the detecting unit.

11. A communication method comprising:
allocating a plurality of first regions and a plurality of second regions in a frame;
containing portions of a packet in the plurality of first regions;
transmitting the frame; and
containing a retransmission data packet in at least one of the plurality of second regions in accordance to a retransmission request for the packet.

12. The communication method according to claim 11, further comprising:
extending the plurality of second regions in accordance with the retransmission request.

13. The communication method according to claim 12, further comprising:
allocating the plurality of second regions for the retransmission data packet in accordance with the untransmitted amount of data of the retransmission data packet.

14. The communication method according to claim 11, further comprising:
extending the plurality of first regions after the frame containing the retransmission data packet is transmitted.

15. The communication method according to claims 11, further comprising:
dividing the packet; and
containing the divided packet in a plurality of frames.

16. The communication method according to claim 11, further comprising:
containing the retransmission data packet and error encoding for correcting errors in the retransmission data packet in at least one of the plurality of second regions.

17. The communication method according to claim 11, further comprising:
adding individual identification numbers to each packet;
including the identification number in the retransmission request; and
containing the retransmission data packet corresponding to the identification number included in the retransmission request in at least one of the plurality of second regions.

18. The communication method according to claim 11, further comprising:
generating the packet from a data signal continuously input; and
transmitting the frame at a communication speed faster than the communication speed of the data signal.

19. The communication method according to claim 11, further comprising:
detecting errors in packets contained in received frames,
wherein said allocating allocates a plurality of third regions and a plurality of fourth regions to the frame,
wherein said containing contains portions of the packet in the plurality of third regions, and contains the retransmission request for the packet in at least one of the fourth regions when an error is detected in the received packet.
